(19) United States
(12) Patent Application Publication
(10) Pub. No.: US 2009/0044917 A1
(43) Pub. Date: Feb. 19, 2009

(54) OVERHEAD DOORS AND ASSOCIATED TRACK, GUIDE, AND BRACKET ASSEMBLIES FOR USE WITH SAME

(75) Inventor: Michael M. Meichtry, Brookfield, WI (US)

Correspondence Address: PERKINS COIE LLP, P.O. Box 1247, Seattle, WA, 98111-1247, US

(73) Assignee: 4Front Engineered Solutions, Inc., Carrollton, TX (US)

(21) Appl. No.: 12/191,146

(22) Filed: Aug. 13, 2008

Related U.S. Application Data
(60) Provisional application No. 60/956,368, filed on Aug. 16, 2007.
(60) Provisional application No. 60/956,355, filed on Aug. 16, 2007.
(60) Provisional application No. 60/956,363, filed on Aug. 16, 2007.

(51) Int. Cl. E05D 15/00

(52) U.S. Cl. 160/201

(57) ABSTRACT

Overhead door guide assemblies, guide tracks, and guide track support brackets are disclosed herein. An overhead door track assembly configured in accordance with one embodiment of the invention includes a vertical track segment mounted to a wall adjacent an opening therein, and a curved track segment operably coupled to the vertical track segment. The curved track segment includes a first guide surface spaced apart from a second guide surface to define a first gap region that movably receives the door guide members as the door moves away from the opening. The track assembly further includes a non-vertical track segment operably coupled to the curved track segment. The non-vertical track segment includes a third guide surface spaced apart from a fourth guide surface to define a second gap region that movably receives the door guide members from the curved track segment. In this embodiment, the second gap region is wider than the first gap region to reduce binding as the door moves onto the non-vertical track segment.

### CROSS-REFERENCE TO RELATED APPLICATIONS

The present application claims priority to U.S. Provisional Application Ser. No. 60/956,368, filed Aug. 16, 2007, the disclosure of which is incorporated herein by reference in its entirety. The disclosures of the following patent applications are also incorporated herein by reference in their entireties: U.S. Provisional Application Ser. No. 60/956,355, filed Aug. 16, 2007; U.S. Provisional Application Ser. No. 60/956,363, filed Aug. 16, 2007; U.S. application Ser. No. (Attorney Docket No. 633208002US1), entitled “OVERHEAD DOORS AND ASSOCIATED TRACK AND GUIDE ASSEMBLIES FOR USE WITH SAME”, filed concurrently herewith; and U.S. application Ser. No. (Attorney Docket No. 633208003US1), entitled “OVERHEAD DOORS AND ASSOCIATED TRACK GUIDE ASSEMBLIES FOR USE WITH SAME”, filed concurrently herewith.

### TECHNICAL FIELD

The following disclosure relates generally to overhead doors and, more particularly, to overhead door track, guide, and bracket assemblies.

### BACKGROUND

Overhead doors have been used on loading docks and in various other warehouse and factory settings for many years. Conventional overhead doors are of the sectional type, and typically include four or more rectangular panels hinged together along the upper and lower edges. Each of the door panels carries two guide assemblies near the upper hinge line, and the bottom door panel carries two additional guide assemblies near the bottom edge. Each of the guide assemblies typically includes a plunger or roller device that extends outwardly from the door panel and is movably received in a channel section of an adjacent door track. The door tracks extend along the left and right sides of the door, and guide the door as it moves upwardly into the overhead or “open” position.

Many overhead doors include spacers between the door panels for sealing and other reasons. Because the pivot axes of the panel hinges are not collinear with the guide plunger axes, the panel spacers can prevent adjacent door panels from back-bending. This can lead to binding as the door is moved upwardly on curved guide tracks.

Another problem with conventional overhead doors is that they are susceptible to damage when used in factories, warehouses, and other commercial and industrial settings. Occasionally, for example, a forklift operator may inadvertently run into the door, as can happen when the door is in a partially open position. This can damage the door and/or the door tracks, making further use of the door difficult or impossible without time-consuming repairs. One way to overcome this problem is to equip the door with spring-loaded guide assemblies that retract and release from the tracks when struck with sufficient force in one or more directions, as disclosed in, for example, U.S. Pat. No. 5,535,805 to Kellog, et al., U.S. Pat. No. 5,927,368 to Rohrer, et al., U.S. Pat. No. 6,041,844 to Kellog, et al., U.S. Pat. No. 6,095,229 to Kellog, et al., U.S. Pat. No. 6,119,307 to Weishar, et al., and U.S. Pat. No. 6,273,175 to Kellog, et al. (All of the foregoing patents are incorporated into the present disclosure in their entireties by reference).

Although configuring the door to release in one or both directions may avoid damage to the door when struck, this approach can present additional problems. For example, under certain conditions the entire door could be knocked out of the tracks, and reinstalling an entire door can be a difficult and time-consuming task. Furthermore, one or more spreader bars may be necessary to help hold the overhead door tracks in position.

### SUMMARY

The following summary is provided for the benefit of the reader only, and is not intended to limit the invention as set forth by the claims in any way.

The present disclosure is directed generally to overhead door track assemblies and associated backhang brackets. An overhead door track assembly configured in accordance with one aspect of the invention includes a vertical track segment mounted to a wall adjacent an opening therein, and a non-vertical track segment having a proximal end operably coupled to the vertical track segment and a distal end spaced apart from the wall. The non-vertical track segment can include a first side portion spaced apart from a second side portion to define a guide channel therebetween. The guide channel is configured to movably receive at least one door guide member as the door moves away from the opening toward the distal end of the non-vertical track segment. In this aspect of the invention, the track assembly further includes a bracket, e.g., a “backhang” bracket, supporting the distal end of the non-vertical track segment. The bracket is fixedly attached to the first and second side portions of the non-vertical track segment and spans across at least a portion of the guide channel near the distal end of the non-vertical track segment.

A door track assembly configured in accordance with another aspect of the invention includes a vertical track segment, a curved track segment, and a non-vertical track segment. The vertical track segment can be mounted to a wall adjacent an opening therein. The curved track segment can be operably coupled to the vertical track segment, and can include a first guide surface spaced apart from a second guide surface to define a first gap region therebetween. The first gap region can be configured to movably receive at least one door guide member as the door moves away from the opening. The non-vertical track segment can include a proximal end operably coupled to the curved track segment and a distal end spaced apart from the wall. The non-vertical track segment can further include a third guide surface spaced apart from a fourth guide surface to define a second gap region therebetween. In this aspect of the invention, the second gap region can be wider than the first gap region to prevent or at least reduce binding of the at least one door guide member as the door moves from the curved track segment toward the distal end of the non-vertical track segment.

### BRIEF DESCRIPTION OF THE DRAWINGS

FIG. 1 is an isometric view of an overhead door assembly configured in accordance with an embodiment of the invention.

FIG. 2 is an enlarged, cross-sectional end view of a track section and guide assembly configured in accordance with an embodiment of the invention.

FIG. 3 is an enlarged, cross-sectional end view of a track section and guide assembly configured in accordance with another embodiment of the invention.

FIG. 4 is an enlarged side view of a portion of the door track assembly of FIG. 1.

FIG. 5 is an enlarged, cross-sectional end view of a track section and two different door guide assemblies configured in accordance with further embodiments of the invention.

FIGS. 6A and 6B are enlarged, cross-sectional end views of a track section and two different door guide assemblies configured in accordance with additional embodiments of the invention.

FIG. 7 is a partially cut-away, enlarged isometric view of a portion of the door track assembly of FIG. 1.

FIG. 8 is an enlarged isometric view of a distal end portion of the door track assembly of FIG. 1, illustrating a track support bracket configured in accordance with an embodiment of the invention.

FIGS. 9A and 9B are enlarged, cross-sectional end views of the track section shown in FIG. 8.

FIG. 10A is an isometric view of a distal end portion of a door track assembly, illustrating a track support bracket configured in accordance with another embodiment of the invention, and FIG. 10B is an enlarged, cross-sectional end view of the track section shown in FIG. 10A.

FIG. 11A is an isometric view of a distal end portion of a door track assembly, illustrating a track support bracket configured in accordance with a further embodiment of the invention, and FIG. 11B is an enlarged, cross-sectional end view of the track section shown in FIG. 11A.

### DETAILED DESCRIPTION

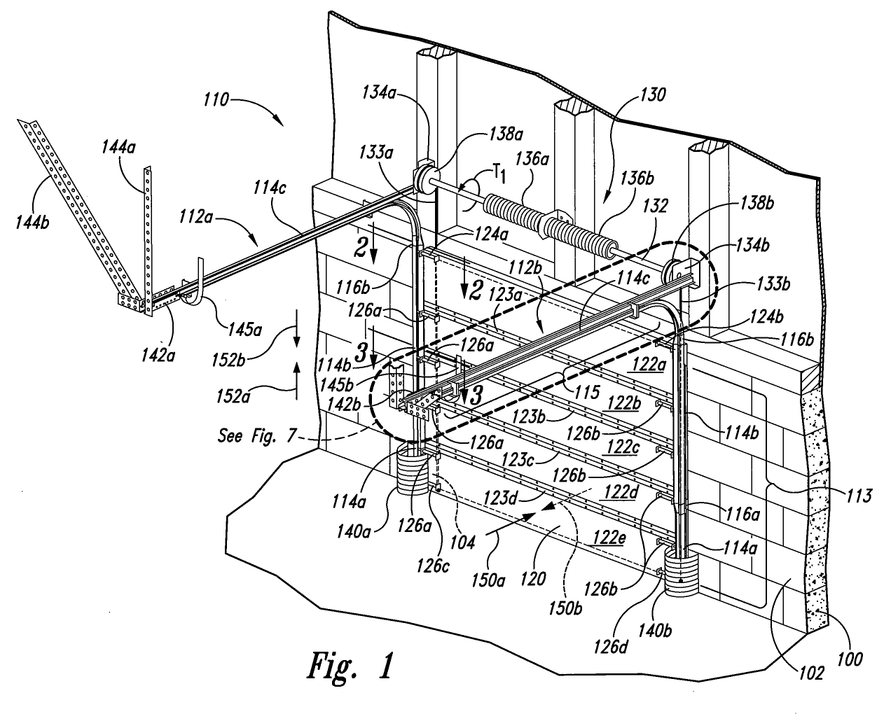

The following disclosure describes various embodiments of overhead door tracks, track support brackets (e.g., “backhang” brackets), and associated door guide assemblies. In one embodiment, for example, an overhead door track has a guide channel that widens as the track curves away from the door opening to prevent, or at least reduce door binding. In another embodiment, a door track backhang bracket spans across the guide channel to act as a secondary door stop mechanism. Certain details about these and other embodiments are set forth in the following description and in FIGS. 1-11B to provide a thorough understanding of various embodiments of the invention. Other details describing well-known structures and systems often associated with overhead doors, overhead door tracks, and overhead door guide assemblies, have not been set forth in the following disclosure to avoid unnecessarily obscuring the description of the various embodiments of the invention.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar elements. To facilitate the discussion of any particular element, the most significant digit or digits of any reference number refer to the Figure in which that element is first introduced. For example, element 110 is first introduced and discussed with reference to FIG. 1.

FIG. 1 is an isometric view of an overhead door assembly 110 configured in accordance with an embodiment of the invention. The overhead door assembly 110 (“door assembly 110”) is installed in an opening 104 in a wall 102 of a building 100. The wall 102 can be part of a loading dock in a warehouse, factory, or other building 100. In other embodiments, however, the door assembly 110 can be installed in other types of openings in other commercial and non-commercial buildings.

The overhead door assembly 110 includes a sectional door 120 that is movably supported in opposing track assemblies 112 (identified individually as a left or first track assembly 112a and a right or second track assembly 112b). The sectional door 120 includes a plurality of rectangular door panels 122 (identified individually as door panels 122a-e) which are pivotally attached to each other along hinge lines 123 (identified individually as hinge lines 123a-d). In one aspect of this embodiment, the first door panel 122a carries a first interlocking guide assembly 124a that movably engages the first track assembly 112a, and a second interlocking guide assembly 124b that movably engages the second track assembly 112b. Each of the remaining door panels 122b-e carries a first releasable guide assembly 126a that movably engages the first track assembly 112a at least proximate to the upper hinge line 123, and a second releasable guide assembly 126b that movably engages the second track assembly 112b at least proximate to the upper hinge line 123. In addition, the fifth door panel 122e carries a third releasable guide assembly 126c that movably engages the first track assembly 112a at least proximate to a lower edge of the door panel 122e, and a fourth releasable guide assembly 126d that movably engages the second track assembly 112b at least proximate to the lower edge of the door panel 122e.

In other embodiments, overhead doors configured in accordance with the present disclosure can include other guide assembly arrangements that differ from that illustrated in FIG. 1. For example, in another embodiment, each of the door panels 122a-d can utilize the interlocking guide assemblies 124, and only the lowermost door panel 122e can utilize the releasable guide assemblies 126. In yet another embodiment, all of the door panels 122 can utilize the interlocking guide assemblies 124. Accordingly, the invention is not limited to the particular guide assembly configuration illustrated in FIG. 1.

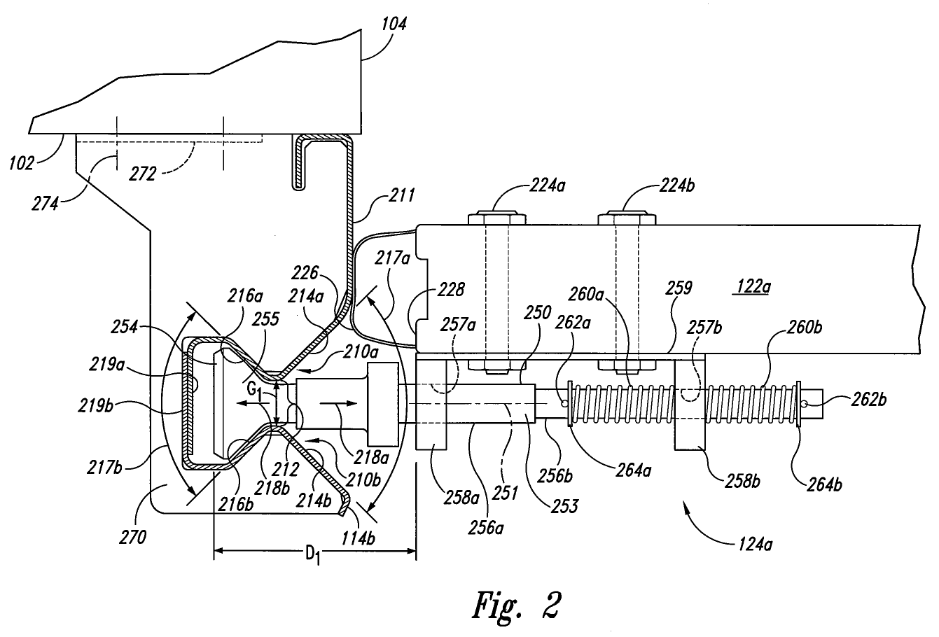

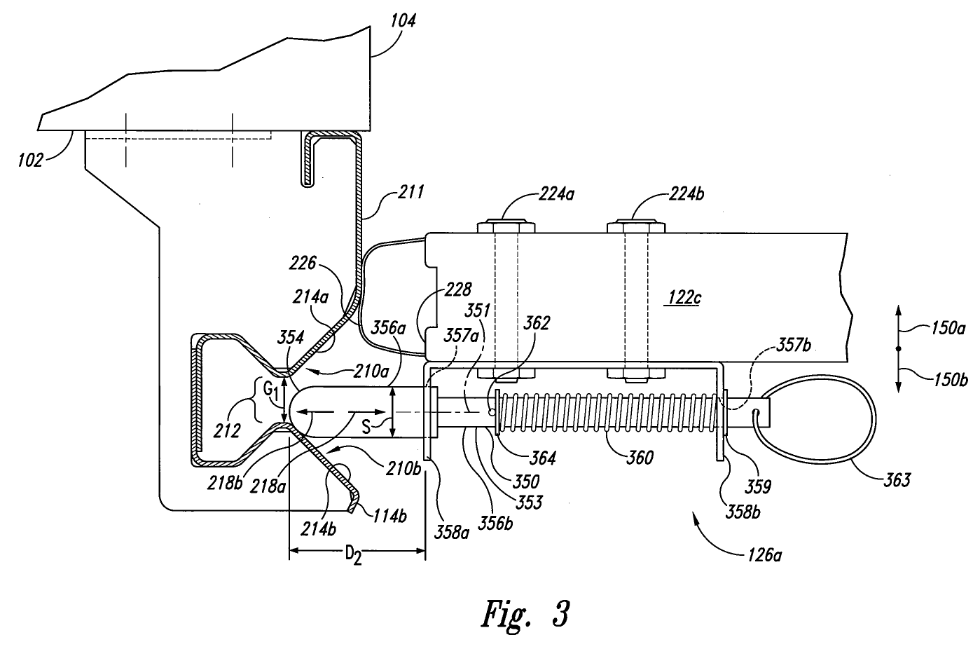

In one aspect of this embodiment, the interlocking guide assemblies 124 can include an “interlocking” guide member that is retained in the adjacent track section when subjected to a force in an outward or first direction 150a or an inward or second direction 150b. In contrast, the releasable guide assemblies 126 can include a “releasable” guide member that disengages from the adjacent track section (thereby allowing the corresponding door panel 122 to be “knocked-out”) when subjected to a sufficient force in one or both of the first direction 150a and/or the second direction 150b. These and other details of the guide assemblies 124 and 126 are described in greater detail below with reference to, for example, FIGS. 2 and 3.

In the illustrated embodiment, each of the track assemblies 112 includes a vertical track segment 113 secured to the wall 102 proximate the opening 104, and a non-vertical track segment 115 which extends away from the wall 102 above the door opening 104. A guard rail 140, or a similar type of protective structure, can be installed around the lower portion of each of the vertical track segments 113 to protect it from damage from forklifts or other impacts. The distal end of each of the non-vertical track segments 115 can be attached to an overhead support system 144 by a corresponding backhang bracket 142 (identified individually as a first backhang bracket 142a and a second backhang bracket 142b). The support system 144 can include a vertical member 144a and a diagonal member 144b having distal ends that are fixedly attached to adjacent building structures for support. A door bumper 145, made of spring steel or other suitable material, can be fixedly attached near the distal end of each of the non-vertical track segments 115 to act as a primary door travel stop system and absorb the kinetic energy of the door 120 as it moves into the overhead position.

Each of the track assemblies 112 includes a plurality of multi-piece track sections 114 (identified individually as a first track section 114a, a second track section 114b, and a third track section 114c) operably coupled together in functional alignment at a first transition section 116a and a second transition section 116b. In one aspect of this embodiment, each of the track sections 114a-c has a different cross-sectional shape that provides different door knock-out capabilities at different locations along the track. For example, in the illustrated embodiment, the cross-sectional shape of the first track section 114a allows the releasable guide assemblies 126 to disengage from the track section 114a when subjected to a force of a predetermined magnitude in the first direction 150a. This same cross-sectional shape, however, does not allow the releasable guide assemblies 126 to disengage from the first track section 114a when subjected to a force in the opposite, second direction 150b.

Turning now to the second track section 114b, this track section has a cross-sectional shape that allows the releasable guide assemblies 126 to disengage when subjected to a force of sufficient magnitude in either the first direction 150a or the second direction 150b. The third track section 114c has yet another cross-sectional shape that differs from both the first track section 114a and the second track section 114b. More specifically, the third track section 114c has a cross-sectional shape (or shapes) that retains both the releasable guide assemblies 126 and the interlocking guide assemblies 124 when the door 120 is in the overhead position, even when the door 120 is subjected to a substantial force in an upward or third direction 152a or a downward or fourth direction 152b. These and other features of the track sections 114 are described in greater detail below with reference to FIGS. 2-11B.

In a further aspect of this embodiment, the overhead door assembly 110 also includes a counterbalance system 130 fixedly attached to the building 100 above the door opening 104. The counterbalance system 130 can include a first cable 133a and a second cable 133b which are attached to the lower-most door panel 122e. The counter balance cables 133 may also be attached to other door panels 122 at the top or bottom. Each of the cables 133 is operably coupled to a corresponding cable drum 138 (identified individually as a first cable drum 138a and a second cable drum 138b). The cable drums 138 are fixedly attached to an axle 132 which is rotatably supported by opposing bearing supports 134a and 134b. A first coil spring 136a and a second coil spring 136b are operably wound about the axle 132, and exert a torsional force T₁ on the cable drums 138 which is proportional to the amount of cable extension. The torsional force T₁ puts the cables 133 in tension, making it easier for a person to lift the door 120 and allowing the door 120 to close or lower at a controlled rate of speed

In operation, a person wishing to open the door 120 simply grasps the door 120 and lifts after disengaging any door locks (not shown). As the door 120 moves upwardly, the door panels 122 curve around the bends in the third track sections 114c and move inwardly on the non-vertical track segments 115 toward the bumpers 145. Although not shown in FIG. 1, in an alternate embodiment the overhead door assembly 110 can be equipped with an electric motor or other automated device for opening the door 120. With the door 120 stowed in the overhead position, personnel can transport goods and materials through the opening 104 by forklift, dolly, or other conveyance.

In the embodiment of FIG. 1, the door 120 moves upwardly and then away from the wall 102 in a horizontal direction. In other embodiments, however, an overhead door configured in accordance with the present disclosure can move away from the opening 104 in multiple directions. For example, the door 120 can move along tracks that extend away from the wall 102 at any angle from about 0 degrees (i.e., parallel to the wall 102) to about 90 degrees (i.e., horizontal, as shown in FIG. 1). Accordingly, those of ordinary skill in the relevant art will appreciate that the present invention is not limited to the particular embodiment disclosed in FIG. 1, but extends to other embodiments incorporating the inventive features disclosed herein.

FIG. 2 is an enlarged, cross-sectional end view taken along line 2-2 in FIG. 1, showing the interlocking guide assembly 124a movably engaged with the second track section 114b in accordance with an embodiment of the invention. In one aspect of this embodiment, the second track section 114b is formed from two separate side portions 210 (identified individually as a first side portion 210a and a second side portion 210b) which are joined together along overlapping flanges 219 (identified individually as a first flange 219a and a second flange 219b). In one embodiment, the flanges 219 can be joined together by a plurality of “clinched” connections formed by a process known as “clinching.” Clinching is a method of joining two pieces of sheet metal by pressing them together with a die that forms a connection similar to a rivet. Hand operated clinching tools are typically hydraulically driven, and make a connection by driving a punch into the die through overlapping material. When the material is forced to the bottom of the die, the material begins to mushroom and expands to allow full development of the connection. When the punch reaches its force limit, it is withdrawn. The result is a connection very similar to a riveted connection. In other embodiments, however, the flanges 219 can be joined together using a number of different techniques including, for example, fastening with rivets, screws, bolts, etc., bonding, welding, and/or other suitable methods known in the art.

The first side portion 210a is spaced apart from the second side portion 210b to define a first gap region 212 therebetween. The first gap region 212 has a first width or first gap dimension G₁. The first side portion 210a includes a first guide surface 214a and a first retention surface 216a. Similarly, the second side portion 210b includes a second guide surface 214b and a second retention surface 216b. In the illustrated embodiment, the first and second guide surfaces 214 diverge from the first gap region 212 in a fifth direction 218a to form a first “V-groove,” and the first and second retention surfaces 216 diverge from the first gap region 212 in a sixth direction 218b, opposite to the fifth direction 218a, to form a second “V-groove.” More specifically, in the illustrated embodiment, the first guide surface 214a is disposed at a first angle 217a of from about 60 degrees to about 120 degrees, e.g., about 90 degrees relative to the second guide surface 214b. The first retention surface 216a can be disposed at a second angle 217b of from about 40 degrees to about 180 degrees relative to the second retention surface 216b. For example, in one embodiment the first retention surface 216a can be disposed at a second angle 217b of from about 60 degrees to about 160 degrees, e.g., about 120 degrees relative to the second retention surface 216b. As described in greater detail below, however, in other embodiments the first and second guide surfaces 214, and/or the first and second retention surfaces 216, can be disposed at other angles, or be parallel, relative to each other.

In addition to the foregoing surfaces, the second track section 114b further includes a seal surface 211 extending from the first guide surface 214a. As illustrated in FIG. 2, the first door panel 122a carries a compressible door seal 226 that slideably contacts the seal surface 211. The door seal 226 can be manufactured from rubber, polyurethane, foam, and/or any other suitable material known in the art.

In one embodiment, the side portions 210 can be formed with a brake press from a suitable sheet metal, such as galvanized steel having a thickness ranging from about 10 gauge to about 20 gauge, e.g. about 16 gauge. In other embodiments, the side portions 210 can be roll- or press-formed from a suitable sheet metal. One advantage of making the track sections 114 from two (or more) pieces of formed sheet metal is that the individual side portions 210 have shapes that are relatively easy to form by conventional brake- and roll-forming methods. In further embodiments, however, the side portions 210, and/or other overhead door track components embodying the inventive features disclosed herein, can be machined, cast, or otherwise formed from other metallic and non-metallic materials having suitable strength, stiffness, forming, cost, and/or other characteristics. Accordingly, those of ordinary skill in the art will appreciate that aspects of the present invention are not limited to the particular manufacturing methods disclosed herein.

In another aspect of this embodiment, the interlocking guide assembly 124a includes an interlocking guide member 250 that projects outwardly from a door edge region 228 a distance D₁ along a longitudinal axis 251 of the guide member 250. The interlocking guide member 250 includes a cylindrical shaft 253 having a first shaft portion 256a and a smaller-diameter second shaft portion 256b. The first shaft portion 256a extends through a first aperture 257a in a first journal 258a. The second shaft portion 256b extends from the first shaft portion 256a through a coaxial second aperture 257b in a second journal 258b. The journals 258 are carried by a bracket 259 which is fixedly attached to the first door panel 122a by a plurality of bolts 224 or other suitable fasteners and/or methods known in the art.

In a further aspect of this embodiment, the distal end of the first shaft portion 256a carries an enlarged head portion 254 that is movably retained by the retention surfaces 216 of the second track section 114b. In the illustrated embodiment, the enlarged head portion 254 flares outwardly from the first shaft portion 256a to form a reverse conical, or at least generally conical, surface 255. Moreover, in the illustrated embodiment the angle of the surface 255 is at least generally similar, or at least approximately parallel, to the angle 217b between the adjacent retention surfaces 216.

In one embodiment, the first shaft portion 256a can have a diameter of from about 0.25 inch to about 0.75 inch, e.g., about 0.50 inch, and the first gap dimension G₁ can be from about 0.375 inch to about 0.875 inch, e.g., about 0.625 inch to provide sufficient clearance for the first shaft portion 256a while still retaining the enlarged head portion 254. In other embodiments, however, other configurations of interlocking guide members and associated track sections can be employed without departing from the spirit or scope of the present disclosure. For example, in other embodiments consistent with the present disclosure, the enlarged head portion 254 can have other shapes, such as spherical shapes, cylindrical shapes, etc., and the adjacent track surfaces can have other shapes that may or may not reflect the shape of the enlarged head portion. In still further embodiments, interlocking guide members can include rollers or similar devices attached to the distal end of the first shaft portion 256a to function as the enlarged head portion 254. As the foregoing illustrates, the present invention is not limited to the particular interlocking guide assembly illustrated in FIG. 2, but extends to other embodiments incorporating the various features disclosed herein.

In another aspect of this embodiment, the second shaft portion 256b carries first and second coil springs 260a, b which are compressed against opposite sides of the second journal 258b and held in place by washers 264 and associated pins 262. The coil springs 260 permit the guide member 250 to move back and forth along the longitudinal axis 251 a preset distance, such as from about 0.1 inch to about 0.5 inch, e.g., about 0.25 inch. This movement enables the guide member 250 to accommodate minor misalignments of the track section 114b without binding.

A track bracket 270 fixedly attaches the second track section 114b to the wall 102. In one aspect of this embodiment, the track bracket 270 can include a mounting flange 272 through which one or more fasteners 274 extend to attach the track bracket 270 to the wall 102.

FIG. 3 is an enlarged, cross-sectional end view taken along line 3-3 in FIG. 1, illustrating engagement of the releasable guide assembly 126a with the second track section 114b. The various track section and door panel features described above with reference to FIG. 2 apply to FIG. 3 as well. As can be seen from FIG. 3, however, in this particular embodiment the releasable guide assembly 126a includes a releasable guide member 350 that lacks the enlarged head portion 254 of the interlocking guide member 250 described above.

The releasable guide member 350 projects outwardly from the door edge region 228 along a longitudinal axis 351, and includes a cylindrical shaft 353 having a first shaft portion 356a and a smaller-diameter second shaft portion 356b. The first shaft portion 356a slidably extends through a first aperture 357a in a first journal 358a. The second shaft portion 356b extends from the first shaft portion 356a through a coaxial second aperture 357b in a second journal 358b. The second shaft portion 356b passes through a coil spring 360 that is compressed between the second journal 358b and a washer 364 which is held in place by a pin 362. The washer 364 and the pin 362 can be replaced by an E-ring or other suitable retainer.

The first shaft portion 356a has a constant, or at least approximately constant, diameter S until it reaches a hemispherical, or at least approximately hemispherical head portion 354. The diameter S can be from about 0.50 inch to about 1.0 inch, e.g., about 0.75 inch. In the illustrated embodiment, the first gap dimension G₁ is smaller than the diameter S (e.g., the first gap dimension G₁ can be about 0.625 inch) to prevent interference of the head portion 354 with the first gap region 212 during door operation. If this were to happen, it could impede the knock-out capability of the releasable guide member 350. The first shaft portion 356a, or parts thereof, can be made from a suitable polymer material, such as plastic, Delrin®, Teflon®, etc. to reduce friction between it and the track section 114b.

The coil spring 360 urges the first shaft portion 356a outwardly in the sixth direction 218b toward the second track section 114b. An E-ring or other type of retainer 359 is fixedly attached to the second shaft portion 356b, however, to prevent the head portion 354 from projecting beyond a distance D₂ from the edge region 228 of the door panel 122c. The distance D₂ is less than the distance D₁ discussed above with reference to FIG. 2. As described in greater detail below, the coil spring 360 allows the head portion 354 to move inwardly in the fifth direction 218a a preset distance, such as from about 0.5 inches to about 1.5 inches, e.g., about 1.25 inches.

The releasable guide member 350 allows the third door panel 122c to be disengaged or “knocked-out” of the second track section 114b when a force of sufficient magnitude is exerted against the door panel 122c in the outward or first direction 150a or the inward or second direction 150b. For example, when the door panel 122c is subjected to a force of sufficient magnitude in the first direction 150a, the force causes the rounded head portion 354 of the guide member 350 to bear against the first guide surface 214a. The angle of the guide surface 214a causes the guide member 350 to retract inwardly in the fifth direction 218a as the door panel 122c continues moving outwardly in the first direction 150a. Once the head portion 354 is sufficiently retracted, the releasable guide member 350 moves free of the “V-groove” formed by the guide surfaces 214. The releasable guide assembly 126a can further include a D-ring or other type of pull feature 363 for manually retracting the releasable guide member 350 if desired to facilitate door panel installation, reinstallation, or removal.

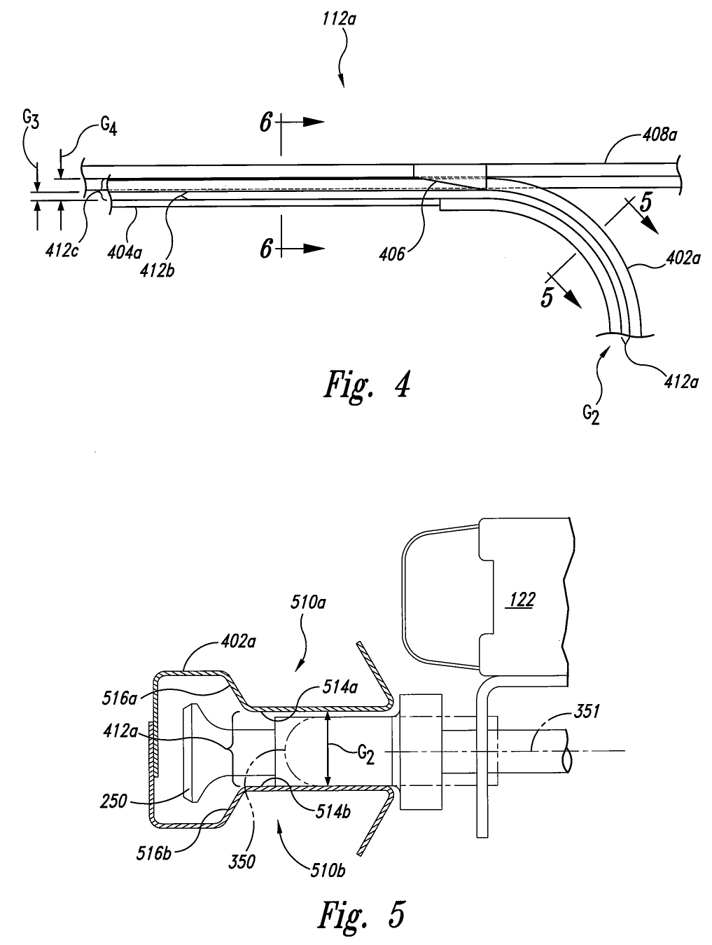

FIG. 4 is an enlarged side view of a portion of the first track assembly 112a of FIG. 1, configured in accordance with an embodiment of the invention. In one aspect of this embodiment, the first track assembly 112a includes a first curved track segment 402a and a first non-vertical track segment 404a. The non-vertical track segment 404a includes a first track brace 408a which extends toward the wall 102 of the building 100 (FIG. 1). The curved track segment 402a includes a second gap region 412a having a second gap dimension G₂. The non-vertical track segment 404a includes the third gap region 412b and a fourth gap region 412c. The third gap region 412b has a third gap dimension G₃, and the fourth gap region 412c has a fourth gap dimension G₄. The track assembly 112a further includes a transition section 406 to accommodate the step up from the second gap region 412a of the curved track segment 402a to the fourth gap region 412c of the non-vertical track segment 404a.

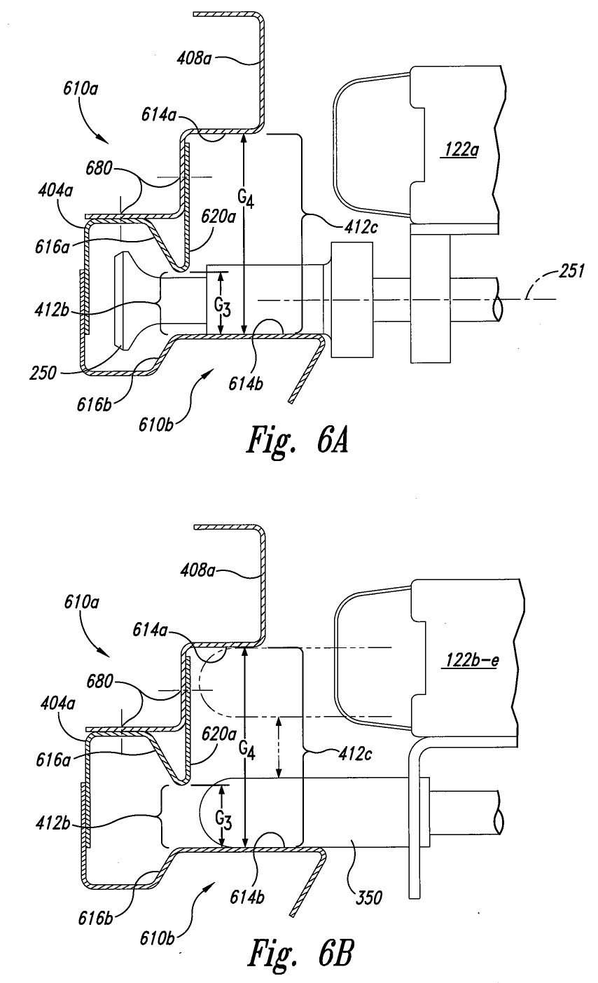

As described in greater detail below with reference to FIG. 5, the second gap region 412a in the curved track segment 402a movably receives the interlocking guide member 250 and the releasable guide member 350 (FIGS. 2 and 3, respectively) as the door 120 moves away from the opening 104 (FIG. 1). As described in greater detail below with reference to FIGS. 6A and 6B, however, as the door 120 moves onto the non-vertical track segment 404a, only the third gap region 412b receives the interlocking guide member 250. The releasable guide member 350, on the other hand, is free to move within the wider fourth gap region 412c. The increased width of the fourth gap region 412c enables the door panels 122 (FIG. 1) to move into the overhead position without binding.

FIG. 5 is an enlarged, cross-sectional end view taken along line 5-5 in FIG. 4. This view illustrates the interlocking guide member 250 and the releasable guide member 350 (shown in phantom line) movably received in the second gap region 412a of the curved track segment 402a. In one aspect of this embodiment, the second gap region 412a defines a guide channel that extends between a third side portion 510a and a fourth side portion 510b. The third side portion 510a includes a third guide surface 514a and a third retention surface 516a. Similarly, the fourth side portion 510b includes a fourth guide surface 514b and a fourth retention surface 516b. The guide surfaces 514 extend parallel, or at least approximately parallel, to the longitudinal axis 351 of the releasable guide member 350 (FIG. 3) to prevent the releasable guide member 350 from being knocked out of the curved track segment 402 during door operation. The retention surfaces 516 are at least generally similar in structure and function to the retention surfaces 216 described above with reference to FIG. 2. In the illustrated embodiment, the second gap dimension G₂ can be slightly larger than the first gap dimension G₁ shown in FIGS. 2 and 3, to reduce skidding and/or scuffing of the releasable guide member 350 and the interlocking guide member 250 as hey move through the second gap region 412a. For example, the second gap dimension G₂ can be from about 0.625 inch to about 1.125 inches, e.g., about 0.875 inch. In other embodiments, however, the second gap region 412a can have other dimensions.

FIGS. 6A and 6B are enlarged, cross-sectional end views taken along line 6-6 in FIG. 4. More specifically, FIG. 6A shows the interlocking guide member 250 movably engaged with the non-vertical track segment 404a, and FIG. 6B shows the releasable guide member 350 movably engaged with the non-vertical track segment 404a. Referring first to FIG. 6A, the non-vertical track segment 404a includes a fifth side portion 610a spaced apart from a sixth side portion 610b. The fifth side portion 610a includes a fifth guide surface 614a and a fifth retention surface 616a. The sixth side portion 610b includes a sixth guide surface 614b and a sixth retention surface 616b. When the non-vertical track segment 404a is operably connected to the curved track segment 402a (FIG. 4), the fifth retention surface 616a is at least approximately aligned with the third retention surface 516a (FIG. 5), the sixth retention surface 616b is at least approximately aligned with the fourth retention surface 516b, and the sixth guide surface 614b is at least approximately aligned with the fourth guide surface 514b.

In one aspect of this embodiment, the third gap region 412b extends between the sixth side portion 610b and a first upper track rail 620a that is fastened or otherwise attached to the track brace 408a. The upper track rail 620a can be fastened to the track brace 408a by a plurality of mechanically “clinched” connections 680, or by other suitable fastening techniques known in the art. In another aspect of this embodiment, the fourth gap region 412c extends between the fifth guide surface 614a and the sixth guide surface 614b. The guide surfaces 614 extend at least approximately parallel to the longitudinal axis 251 of the interlocking guide member 250.

During normal door operation, the interlocking guide member 250 moves back and forth in the third gap region 412b, but is held in the non-vertical track segment 404a by the retention surfaces 616. As shown in FIG. 6B, however, the releasable guide member 350 not only moves back and forth, but it can also move up and down in the fourth gap region 412c because of the enlarged fourth gap dimension G₄. This freedom of movement can alleviate binding as the door moves from the curved track segment 402a (FIG. 4) to the non-vertical track segment 404a. More specifically, conventional doors may bind during retraction because spacers between the adjacent door panels prevent them from back-bending as necessary as they move from the curved track segments to the non-vertical track segments. In contrast, the guide channel of the present invention enables doors to move smoothly through curved track segments by providing additional clearance for the releasable guide members 350. In the illustrated embodiment, the third gap dimension G₃ can be slightly smaller than the second gap dimension G₂ shown in FIG. 5, to prevent the releasable guide member 350 from extending through the third gap region 412b during normal door operation. For example, the third gap dimension G₃ can be from about 0.375 inch to about 0.875 inch, e.g., about 0.625 inch. In other embodiments, however, the third gap region 412b can have other dimensions

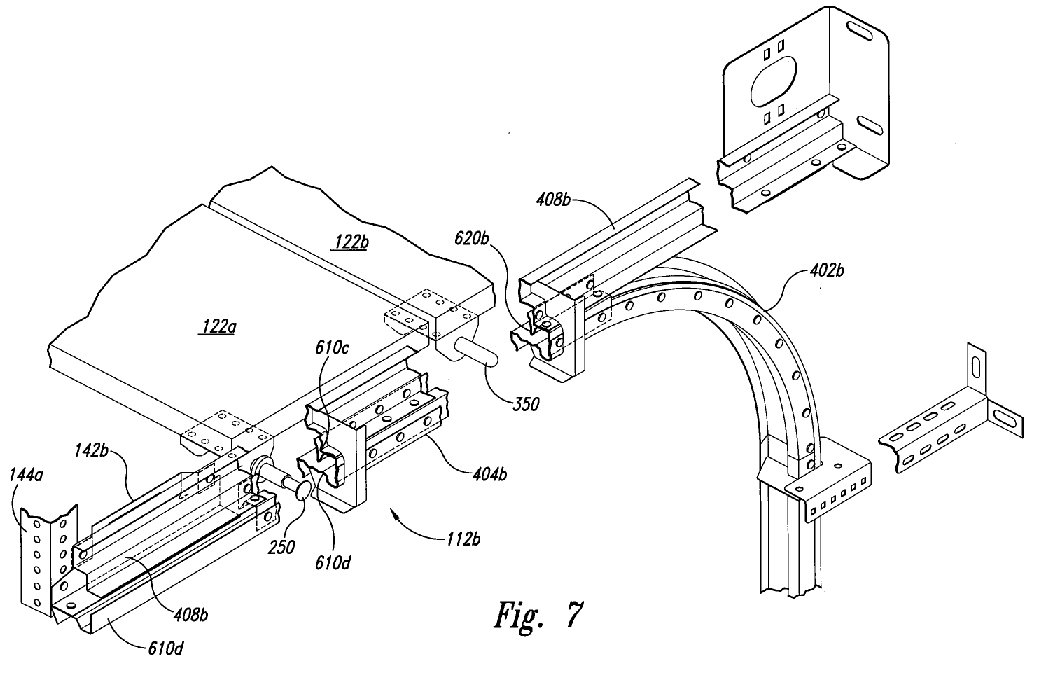

FIG. 7 is an enlarged, partially cut-away isometric view of a portion of the second track assembly 112b of FIG. 1. The second door bumper 145b of FIG. 1 has been omitted from FIG. 7 for purposes of clarity. The second track assembly 112b is, in general at least, a mirror image of the first track assembly 112a described in detail above. Accordingly, the second track assembly 112b is at least generally similar in structure and function to the first track assembly 112a. For example, the second track assembly 112b includes a second curved track segment 402b operably connected to a second non-vertical track segment 404b. The non-vertical track segment 404b includes a second track brace 408b which is attached to the wall 102 (FIG. 1). The non-vertical track segment 404b includes a seventh side portion 610c spaced apart from an eighth side portion 610d. The seventh side portion 610c is formed by a second upper track rail 620b that is fastened or otherwise attached to the second track brace 408b.

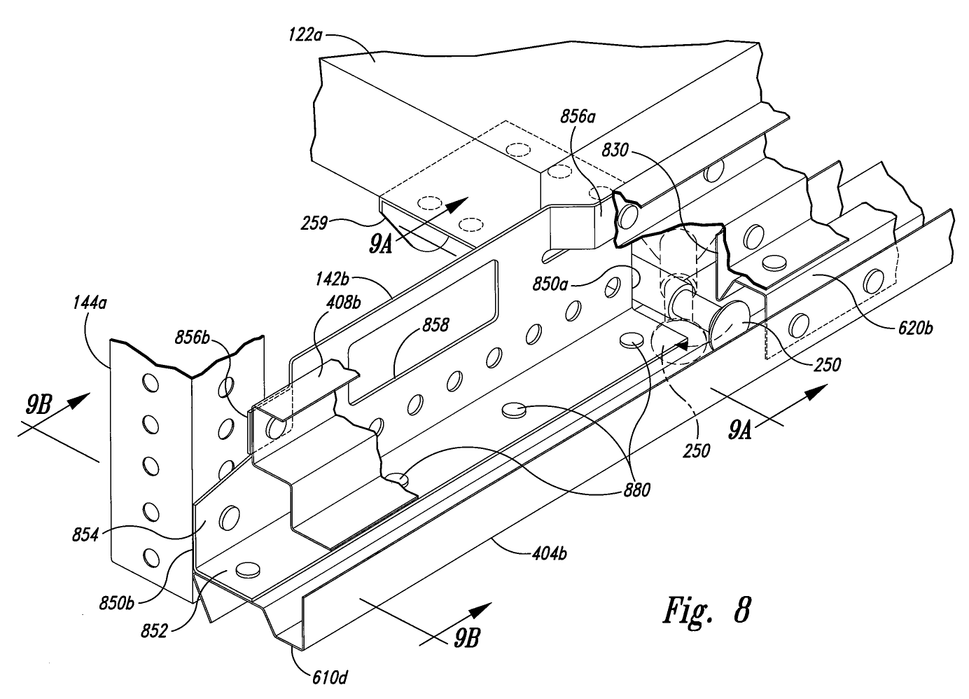

FIG. 8 is an enlarged isometric view of the distal end portion of the second track assembly 112b of FIG. 7, showing various features of the second backhang bracket 142b in more detail. In one aspect of this embodiment, the backhang bracket 142b includes an upstanding flange 854 extending from a base flange 852. The base flange 852 is fixedly attached to the eighth side portion 610d of the non-vertical track segment 404b with a plurality of clinched connections or other suitable fasteners 880. The upstanding flange 854 includes a first tab 856a positioned toward a leading edge 850a, and a second tab 856b positioned toward a trailing edge 850b. The tabs 856 are fixedly attached to an upper flange portion of the second track brace 408b.

In the illustrated embodiment, the upper track rail 620b does not extend to the distal end of the non-vertical track segment 404b, but instead has an end edge 830 that is positioned just short of the leading edge 850a of the backhang bracket 142b. Truncating the upper track rail 620b at this location enables a technician or other service personnel to remove the interlocking guide member 250 from the non-vertical track segment 404b if needed for maintenance, repairs, replacement, etc. This can be accomplished by first detaching the bracket 259 from the door panel 122a, rotating the guide member 250 as shown by the dotted lines in FIG. 8, and then extracting the guide member 250 from the non-vertical track segment 404b. An access aperture 858 in the backhang bracket 142b may provide access to one or more of the fasteners (not shown) that attach the door bumper 145b (FIG. 1) to the backhang bracket 142b.

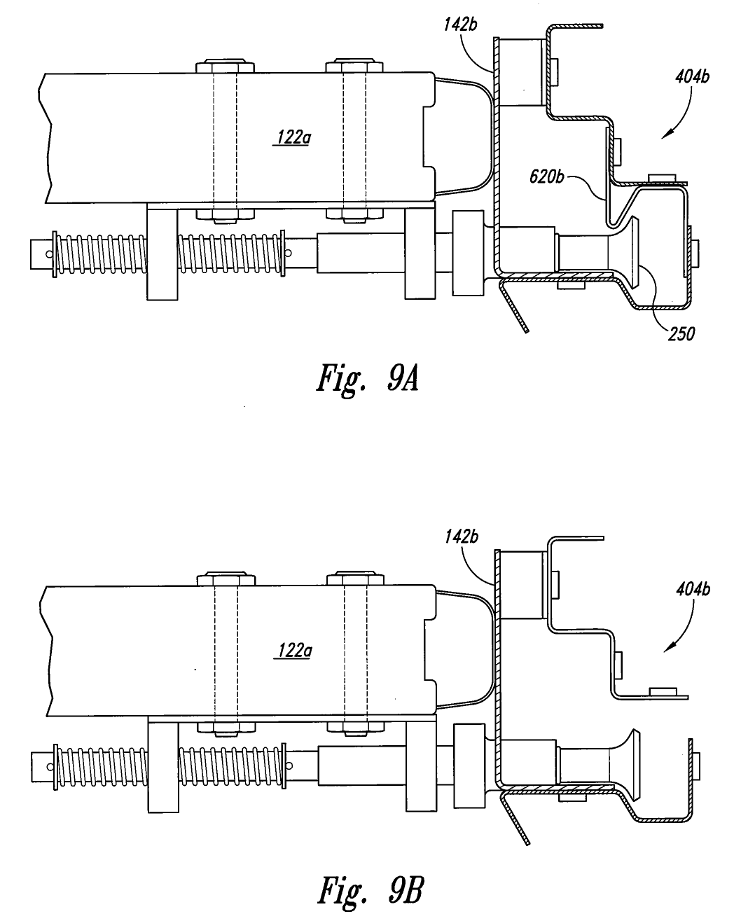

FIGS. 9A and 9B are enlarged, cross-sectional end views taken along lines 9A-9A and 9B-9B in FIG. 8, respectively. These figures illustrate how the backhang bracket 142b can function as a secondary door stop system. For example, if one or both of the door bumpers 145 (FIG. 1) fail (or are removed), the door 120 may continue moving aft on the non-vertical track segments 404 when the door 120 is lifted to the overhead position. Eventually, however, the interlocking guide members 250 will run into the leading edges 850a (FIG. 8) of the corresponding backhang brackets 142, as shown in FIGS. 9A and 9B. A further feature of the backhang bracket assembly illustrated in FIG. 9B is that the upper track rail 620b does not extend to the distal end of the non-vertical track segment 404b.

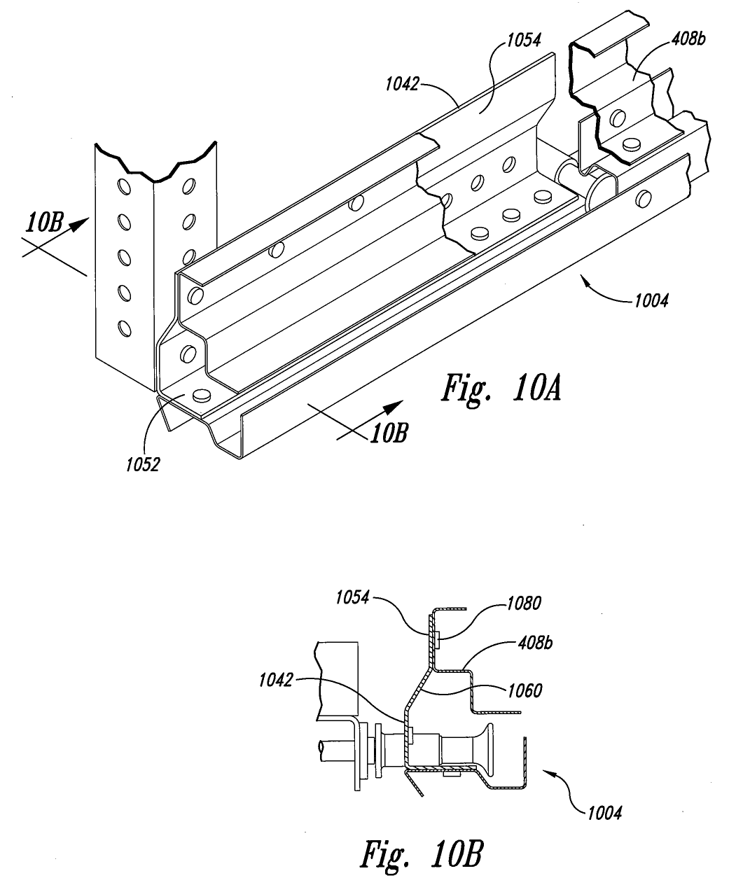

FIG. 10A is an enlarged, partially cut-away isometric view of a distal end portion of a non-vertical track segment 1004 having a backhang bracket 1042 configured in accordance with another embodiment of the invention. FIG. 10B is a cross-sectional end view taken along line 10B-10B in FIG. 10A. Referring to FIGS. 10A and 10B together, Many features of the non-vertical track segment 1004 are at least generally similar in structure and function to corresponding features of the non-vertical track segment 404b described in detail above with reference to FIGS. 7-9B. For example, the backhang bracket 1042 includes an upstanding flange 1054 that extends from a base flange 1052. In one aspect of this particular embodiment, however, the upstanding flange 1054 includes a joggle 1060 that positions the upstanding flange 1054 in contact with the track brace 408b so that the upstanding flange 1054 can be fastened to the track brace 408b with a plurality of clinched connections or other suitable fasteners 1080.

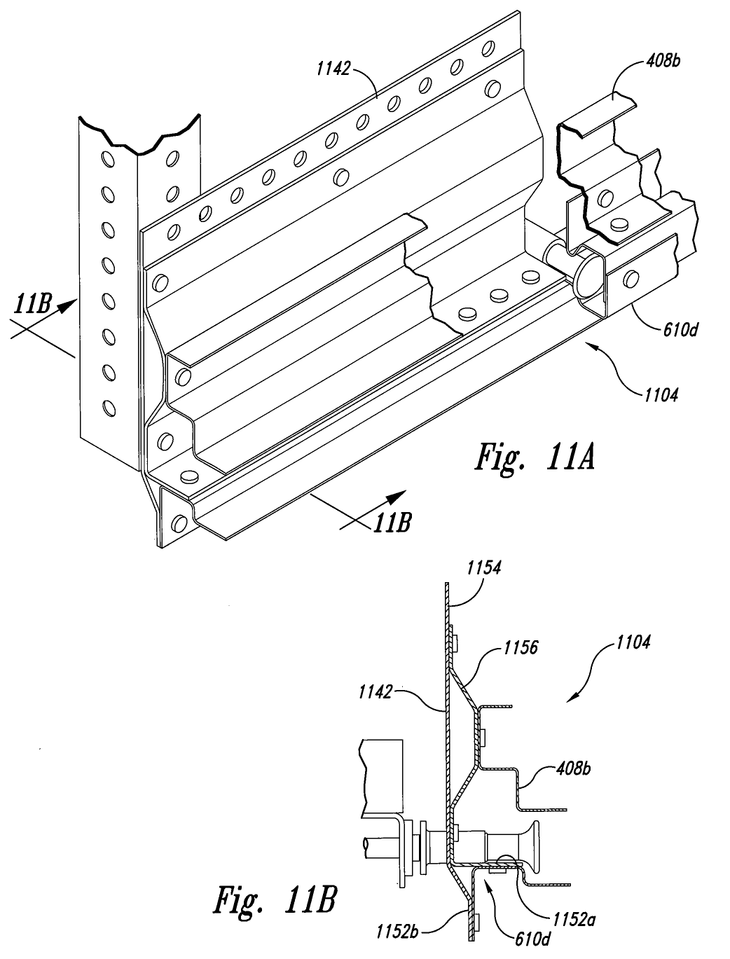

FIG. 11A is an enlarged, partially cut-away isometric view of a distal end portion of a non-vertical track segment 1104 configured in accordance with yet another embodiment of the invention, and FIG. 11B is a cross-sectional end view taken along line 11B-11B in FIG. 11A. Referring FIGS. 11A and 11B together, many features of the non-vertical track segment 1104 are at least generally similar in structure and function to the corresponding features of the non-vertical track segments 404 and 1004 described above. For example, the non-vertical track segment 1104 includes a backhang bracket 1142 which is fixedly attached to the track brace 408b and the eighth side portion 610d. In one aspect of this particular embodiment, however, the backhang bracket 1142 is a subassembly of sheet metal parts having an upstanding flange 1154 with an offset portion 1156, and two base flanges 1152 (identified individually as a first base flange 1152a and a second base flange 1152b). The two base flanges 1152 provide additional strength and stability to the backhang bracket assembly, while the offset portion 1156 provides an offset surface for fastening the backhang bracket 1142 to the track brace 408b.

As FIGS. 8-11B illustrate, there are a number of different backhang bracket configurations consistent with the present disclosure for stabilizing and strengthening non-vertical overhead door track segments, while also acting as secondary door travel stop systems. Accordingly, those of ordinary skill in the art will appreciate that the present invention is not limited to the particular backhang bracket configurations described above, but extends to multiple other configurations embodying the inventive features set forth in the following claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/we claim:

1. A track assembly for use with an overhead door, the track assembly comprising:
a vertical track segment mounted to a wall adjacent an opening therein;
a non-vertical track segment having a proximal end operably coupled to the vertical track segment and a distal end spaced apart from the wall, the non-vertical track segment further including a first side portion spaced apart from a second side portion to define a guide channel therebetween, the guide channel movably receiving at least one door guide member as the door moves away from the opening toward the distal end of the non-vertical track segment; and
a bracket positioned toward the distal end of the non-vertical track segment, wherein the bracket extends across the guide channel and is fixedly attached to the first side portion and the second side portion.

2. The track assembly of claim 1 wherein the bracket includes a first flange portion fixedly attached to the first side portion and a second flange portion fixedly attached to the second side portion.

3. The track assembly of claim 1, further comprising a track support member extending between the bracket and an adjacent building structure.

4. The track assembly of claim 1 wherein the track assembly further includes a primary door stop system attached to the non-vertical track segment between the distal end and the wall, and wherein the bracket includes a secondary door stop system positioned to contact the at least one door guide member when the primary door stop system is inoperable.

5. The track assembly of claim 1:
wherein the guide channel includes a gap region configured to movably receive a shaft portion of the at least one door guide member;
wherein the first side portion of the non-vertical track segment includes a first guide surface and a first retention surface;
wherein the second side portion of the non-vertical track segment includes a second guide surface and a second retention surface;
wherein the first and second guide surfaces extend away from the gap region toward a first direction;
wherein the first and second retention surfaces diverge from the gap region toward a second direction, opposite to the first direction; and
wherein the bracket is offset from the gap region in the first direction.

6. The track assembly of claim 1 wherein the overhead door includes a first guide member and a second guide member, wherein the first guide member extends a first distance from a door edge region, and the second guide member extends a second distance from the door edge region, the second distance being less than the first distance, and:
wherein the guide channel includes a first gap region having a first width and a second gap region having a second width, the second width being greater than the first width;
wherein the first gap region is configured to movably receive a first shaft portion of the first guide member; and
wherein the second gap region is configured to movably receive a second shaft portion of the second guide member.

7. The track assembly of claim 1 wherein the overhead door includes a first guide member and a second guide member, wherein the first guide member extends a first distance from a door edge region, and the second guide member extends a second distance from the door edge region, the second distance being less than the first distance, and:
wherein the first side portion of the non-vertical track segment includes a first guide surface and a first retention surface;
wherein the second side portion of the non-vertical track segment includes a second guide surface and a second retention surface;
wherein the first retention surface is spaced apart from the second retention surface to define a first gap region having a first width therebetween, wherein the first gap region is configured to movably receive a first shaft portion of the first guide member; and
wherein the first guide surface is spaced apart from the second guide surface to define a second gap region having a second width therebetween, wherein the second width is greater than the first width, and wherein the second gap region is configured to movably receive a second shaft portion of the second guide member.

8. The track assembly of claim 7 wherein the first guide surface of the first side portion is at least approximately parallel to the second guide surface of the second side portion.

9. The track assembly of claim 7:
wherein the first guide surface of the first side portion is at least approximately parallel to the second guide surface of the second side portion; and
wherein the bracket extends perpendicularly to the first and second guide surfaces.

10. A track assembly for use with an overhead door, the track assembly comprising:
a vertical track segment mounted to a wall adjacent an opening therein;
a curved track segment operably coupled to the vertical track segment, wherein the curved track segment includes a first guide surface spaced apart from a second guide surface to define a first gap region therebetween, wherein the first gap region movably receives at least one door guide member as the door moves away from the opening; and
a non-vertical track segment having a proximal end operably coupled to the curved track segment and a distal end spaced apart from the wall, wherein the non-vertical track segment includes a third guide surface spaced apart from a fourth guide surface to define a second gap region therebetween, wherein the second gap region movably receives the at least one door guide member as the door moves from the curved track segment toward the distal end of the non-vertical track segment, and wherein the first gap region has a first width and the second gap region has a second width, greater than the first width.

11. The track assembly of claim 10 wherein the first and second guide surfaces are at least approximately parallel to each other.

12. The track assembly of claim 10 wherein the first, second, third and fourth guide surfaces are at least approximately parallel to each other.

13. The track assembly of claim 10 wherein the fourth guide surface is at least approximately aligned with the second guide surface where the non-vertical track segment is coupled to the curved track segment.

14. The track assembly of claim 10 wherein the third guide surface is offset from the first guide surface proximate to the proximal end of the non-vertical track segment, and wherein the track assembly further includes a transition surface extending from the first guide surface to the third guide surface.

15. The track assembly of claim 10 wherein the curved track segment includes:
a first side portion, the first side portion having the first guide surface and a first retention surface;
a second side portion spaced apart from the first side portion to define the first gap region therebetween, the second side portion having the second guide surface and a second retention surface;
wherein the first and second guide surfaces extend outwardly from the first gap region toward a first direction; and
wherein the first and second retention surfaces diverge from the first gap region toward a second direction, opposite to the first direction.

16. The track assembly of claim 15 wherein the first and second retention surfaces form a V-groove extending inwardly from the first gap region in the second direction.

17. The track assembly of claim 10:
wherein the curved track segment includes:
a first side portion, the first side portion having the first guide surface and a first retention surface; and
a second side portion spaced apart from the first side portion, the second side portion having the second guide surface and a second retention surface, wherein the first and second guide surfaces extend away from the first and second retention surfaces toward a first direction, and wherein the first and second retention surfaces extend away from the first and second guide surfaces toward a second direction, opposite to the first direction; and
wherein the non-vertical track segment includes:
a third side portion, the third side portion having the third guide surface and a third retention surface; and
a fourth side portion spaced apart from the third side portion, the fourth side portion having the fourth guide surface and a fourth retention surface, wherein the third and fourth guide surfaces extend away from the third and fourth retention surfaces toward the first direction, and wherein the third and fourth retention surfaces extend away from the third and fourth guide surfaces toward the second direction.

18. The track assembly of claim 17:
wherein the fourth guide surface is at least approximately aligned with the second guide surface proximate to the proximal end of the non-vertical track segment;
wherein the first retention surface is at least approximately aligned with the third retention surface proximate to the proximal end of the non-vertical track segment; and
wherein the second retention surface is at least approximately aligned with the fourth retention surface proximate to the proximal end of the non-vertical track segment.

19. The track assembly of claim 10 wherein the vertical track segment includes:
a first side portion formed from a first piece of material, the first side portion having a fifth guide surface and a first retention surface;
a second side portion formed from a second piece of material, the second side portion having a sixth guide surface and a second retention surface;
wherein the first side portion is joined to the second side portion to define a third gap region therebetween;
wherein the fifth and sixth guide surfaces diverge from the third gap region toward a first direction; and
wherein the first and second retention surfaces diverge from the gap region toward a second direction, opposite to the first direction.

20. An overhead door assembly for use with an opening in a wall, the overhead door assembly comprising:
a track assembly, the track assembly including:
a vertical track segment mounted to the wall adjacent the opening;
a curved track segment operably coupled to the vertical track segment, wherein the curved track segment includes a first guide surface spaced apart from a second guide surface to define a first gap region therebetween; and
a non-vertical track segment having a proximal end operably coupled to the curved track segment and a distal end spaced apart from the wall, wherein the non-vertical track segment includes a third guide surface spaced apart from a fourth guide surface to define a second gap region therebetween, wherein the first gap region has a first width and the second gap region has a second width, greater than the first width; and
a first door panel having a bottom edge extending between a first side edge and a second side edge;
a first guide assembly attached to the first door panel proximate to the first side edge, wherein the first guide assembly includes a first guide member that movably extends through the first gap region of the curved track segment as the first door panel moves away from the vertical track segment;
a second door panel having a top edge extending between a third side edge and a fourth side edge, wherein the top edge of the second door panel is hingeably attached to the bottom edge of the first door panel; and
a second guide assembly attached to the second door panel proximate to the third side edge, wherein the second guide assembly includes a second guide member having a distal end portion, wherein the distal end portion is movably received between the first and second guide surfaces of the curved track segment as the second door panel moves away from the vertical track segment, and wherein the distal end portion is movably received between the third and fourth guide surfaces of the non-vertical track segment as the second door panel moves away from the curved track segment.

21. The overhead door assembly of claim 20:
wherein the first side portion further includes a first retention surface and the second side portion further includes a second retention surface; and
wherein the first guide member includes a head portion configured to be movably retained by the first and second retention surfaces.

22. The overhead door assembly of claim 21 wherein the first and second guide surfaces extend outwardly from the first gap region toward a first direction, and wherein the first and second retention surfaces diverge inwardly from the first gap region toward a second direction, opposite to the first direction.

23. The overhead door assembly of claim 20:
wherein the first and second guide surfaces extend outwardly from the first gap region toward a first direction;
wherein the first side portion further includes a first retention surface and the second side portion further includes a second retention surface;
wherein the first and second retention surfaces extend inwardly from the first gap region toward a second direction, opposite to the first direction;
wherein the first guide member includes a first head portion configured to be movably retained by the first and second retention surfaces;
wherein the second guide member includes a second head portion configured to be movably received between the first and second guide surfaces; and
wherein the first head portion of the first guide member is larger than the second head portion of the second guide member.
